(19) United States
(12) Patent Application Publication
(10) Pub. No.: US 2015/0120427 A1
(43) Pub. Date: Apr. 30, 2015

(54) USER CONTRIBUTION ADVERTISEMENT SUPPRESSION

(71) Applicant: Microsoft Corporation, Redmond, WA (US)

(72) Inventor: Mike Hayton, Kirkland, WA (US)

(73) Assignee: Microsoft Corporation, Redmond, WA (US)

(21) Appl. No.: 14/066,594

(22) Filed: Oct. 29, 2013

(51) Int. Cl. G06Q 30/02

(52) U.S. Cl. CPC G06Q 30/0231
USPC 705/14.31

(57) ABSTRACT

Embodiments that relate to rewarding a contributor for a contribution to a digital media distribution system are disclosed. For example, in one disclosed embodiment data indicating an interaction by a selected participant with the contribution is received. Using the data, a value is assigned to the interaction. Based on the value assigned to the interaction, an incentive is allocated to the contributor, where the incentive comprises a suppression of advertisements that would otherwise be delivered to the contributor. A delivery of the advertisements to the contributor is suppressed according to the allocated incentive.

### BACKGROUND

Media distribution systems may allow users to browse, download, stream, purchase and otherwise access music, video, and other digital content. These systems may also invite user input related to the digital content. Such input may take a variety of forms, including sharing user-curated playlists of music and posting ratings, reviews, and recommendations of particular content items.

Some user input to the system may generate positive ratings and/or reviews from other users, and may be used by other users to access content via the system. For example, a popular playlist may receive multiple favorable reviews and top ratings, and may be accessed and played by many other users. In some cases, user input may also motivate other users to consume corresponding digital media content from the distribution system and/or otherwise interact with the system, thereby enhancing the overall perceived value and popularity of the system. Some distribution systems may also promote increased user input by recognizing volume users who provide the largest quantities of input.

However, not all user input positively impacts the perceived value of a distribution system. For example, poorly-composed user playlists, specious movie reviews and other low-value input add little perceived value to the system. Further, while a user who submits poor quality input in high quantities may be a highly active participant in the system, such a user may add little value to the system.

### SUMMARY

Various embodiments are disclosed herein that relate to rewarding a contributor in a distribution system based on a contribution made by the contributor, where the contribution relates to one or more digital media items of the system. For example, one disclosed embodiment provides a method that includes receiving data indicating an interaction with the contribution by a selected participant. Using the data, a value is assigned to the interaction with the contribution. Based on the value assigned to the interaction, an incentive is allocated to the contributor, wherein the incentive comprises a suppression of advertisements that would otherwise be delivered to the contributor via a request from the distribution system. The method then includes suppressing a delivery of the advertisements according to the allocated incentive.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter. Furthermore, the claimed subject matter is not limited to implementations that solve any or all disadvantages noted in any part of this disclosure.

### BRIEF DESCRIPTION OF THE DRAWINGS

FIG. 1 is a schematic view of a contribution incentivizer in a distribution system according to an embodiment of the present disclosure.

FIG. 2 is a schematic view of an example screen of the music graphical user interface of FIG. 1.

FIG. 3 is a schematic view of another example screen of the music graphical user interface of FIG. 1.

FIG. 4 is a schematic view of another example screen of the music graphical user interface of FIG. 1.

FIG. 5 is a schematic view of an example screen of the video graphical user interface of FIG. 1.

FIG. 6 is a schematic view of another example screen of the video graphical user interface of FIG. 1.

FIG. 7 is a schematic view of another example screen of the video graphical user interface of FIG. 1.

FIGS. 8A and 8B are a flow chart of a method for rewarding a contributor in a distribution system according to an embodiment of the present disclosure.

FIG. 9 is a simplified schematic illustration of an embodiment of a computing device.

### DETAILED DESCRIPTION

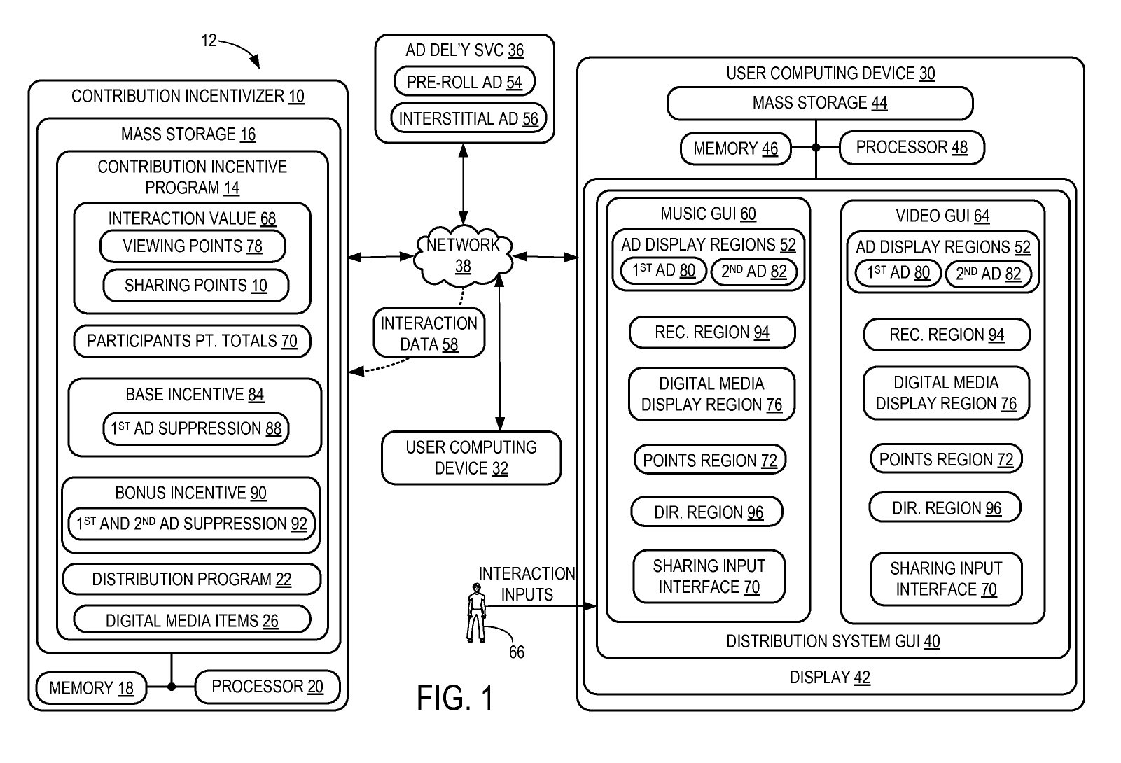

FIG. 1 shows a schematic view of one embodiment of a contribution incentivizer 10 in a digital media distribution system 12. The contribution incentivizer 10 is a hardware device that includes a contribution incentive program 14, which may be stored in mass storage 16 of the contribution incentivizer 10. The contribution incentive program 14 may be loaded into memory 18 and executed by a processor 20 of the contribution incentivizer 10 to perform one or more of the methods and processes described in more detail below. The mass storage 16 may further include a distribution program 22 that instantiates the distribution system 12 and facilitates distribution of digital media items 26, such as music files, music playlists, video files, user and third party reviews, ratings, and recommendations, and related content to users of the system. As described in more detail below, such users of the distribution system 12 are referred to herein as “participants” and “contributors”.

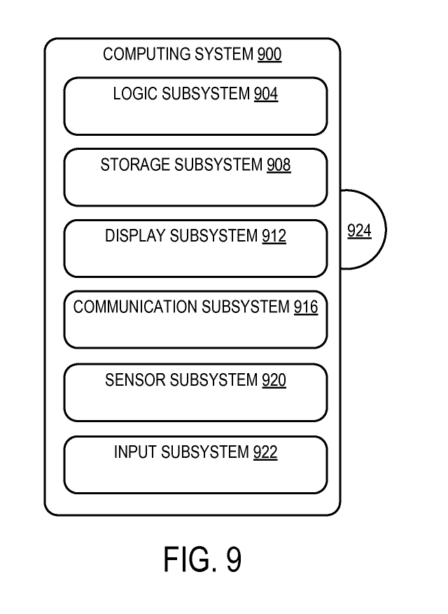

The contribution incentivizer 10 may take the form of a network computing device such as a server, desktop computing device, mobile computing device such as a smart phone, laptop, notebook or tablet computer, or other suitable type of computing device. Additional details regarding the components and computing aspects of the contribution incentivizer 10 are described in more detail below with reference to FIG. 9.

As shown in FIG. 1, the contribution incentivizer 10 may be operatively connected with one or more other computing devices using a wired connection, or may employ a wireless connection via WiFi, Bluetooth, or any other suitable wireless communication protocol. In the example shown in FIG. 1 and as described in more detail below, such other computing devices include a user computing device 30, user computing device 32, and an advertisement delivery service 36. It will be appreciated that the contribution incentivizer 10 may also be operatively connected with additional user computing devices that utilize the distribution system 12.

Also as shown in FIG. 1, the contribution incentivizer 10 may be communicatively coupled to the other computing devices via a network 38. The network 38 may take the form of a local area network (LAN), wide area network (WAN), wired network, wireless network, personal area network, or a combination thereof, and may include the Internet. It will also be appreciated that the contribution incentivizer 10 may be operatively connected with additional user computing devices and/or other computing devices via network 38.

Users of the distribution system 12 may utilize the system to view, stream, download, purchase, rate, review, recommend and otherwise interact with digital media items 26. Users may also contribute to the distribution system 12 by making contributions to the system that may be related to one or more of the digital media items 26. Such contributions may take a variety of forms including, but not limited to, rating, reviewing or recommending a media item, creating and/or curating a music playlist, sharing an item, review, playlist, or other contribution made by another contributor, etc. For purposes of this disclosure, all users of the distribution system 12 are defined as participants, and participants who make one or more contributions to the system are also contributors.

Participants may utilize and interact with the contribution incentivizer 10 and distribution system 12 via a distribution system graphical user interface. In the example shown in FIG. 1, computing device 30 includes a display 42 on which the distribution system GUI 40 may be displayed. The computing device 30 may further include a mass storage 44, memory 46 and processor 48. In one example a distribution system client program (not shown) may be stored in mass storage 44, loaded into memory 46 and executed by processor 48 to generate the distribution system GUI 40. It will be appreciated that the other user computing device 32 shown in FIG. 1 may have a similar arrangement of components as computing device 30 and may similarly display a distribution system GUI via a display device.

The contribution incentivizer 10 may also be communicatively coupled to the advertisement delivery service 36. In some examples, the distribution system 12 may utilize a free, advertisement-supported subscription model in which participants utilize the system in exchange for receiving advertisements delivered from the advertisement delivery service 36. For example, the contribution incentivizer 10 may send a request to the advertisement delivery service 36 to deliver one or more advertisements to the computing device 30 for display in one or more ad display regions 52 in the distribution system GUI 40.

Such advertisements may include audio, video, and audio/video pre-roll ads 54 that may be delivered to the participant before the content selected by the participant is made available. For example, an audio/video pre-roll ad 54 may take the form of a 10 second video commercial with voice-over, a hyperlink to ad-related content and a close button.

Advertisements may also include audio, video, and audio/video interstitial ads 56 that may be delivered to the participant at various times and/or predetermined trigger points. For example, interstitial ads may be delivered at periodic intervals of user activity, natural transition or interaction points in user activity, such as application or media item launch, or at other predetermined times. In one example where a participant is streaming music, an audio interstitial ad 56 may be delivered to the participant after each sequence of 6 songs streamed, and an audio/video interstitial ad may be delivered after 6 “play” requests for music items.

It will be appreciated that the above examples of pre-roll ad 54 and interstitial ad 56 delivery timings and sequences are merely exemplary, and that any other delivery timings and sequences may be utilized and are within the scope of the present disclosure. Additionally, various other forms of online ads including but not limited to banner ads, pop-up ads, hover ads, and any other suitable types and formats of ads may also be utilized and are within the scope of the present disclosure.

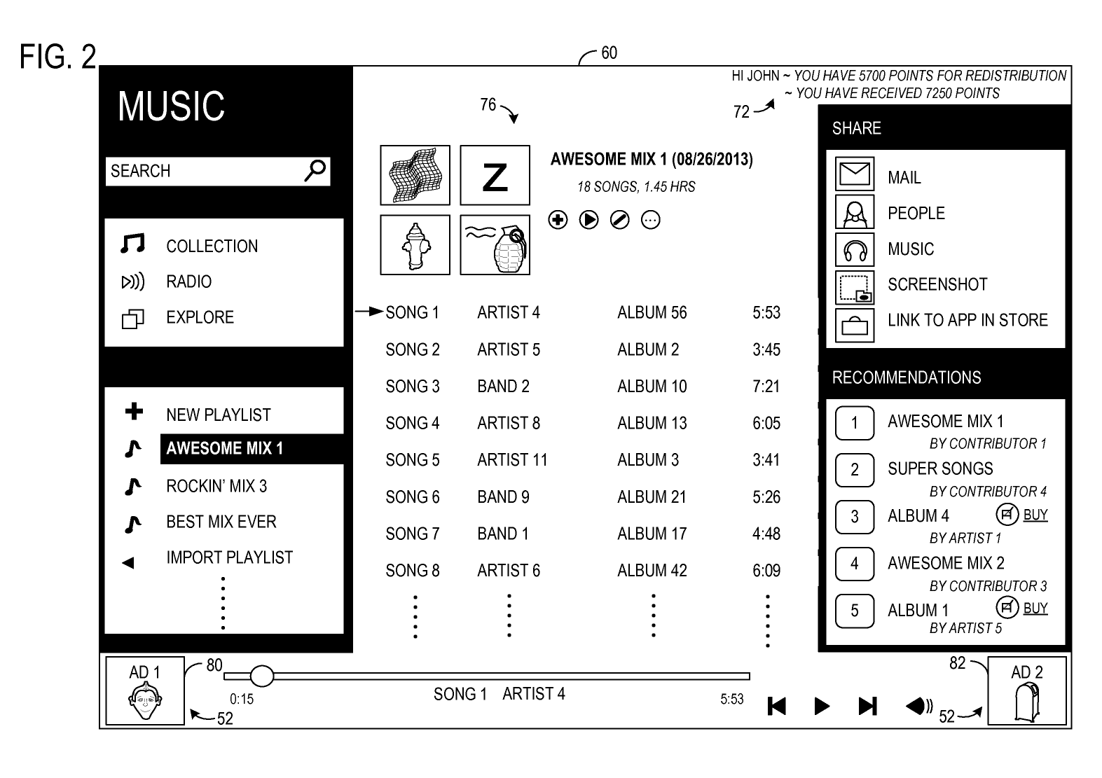

With reference now also to FIGS. 2-7, descriptions of example use cases and embodiments of the contribution incentivizer 10 and distribution system 12 will now be provided. FIGS. 2-7 illustrate example screens of a music GUI 60 and a video GUI 64 that form part of the distribution system GUI 40. As described in more detail below, a participant 66 may utilize the distribution system 12 by providing interaction inputs via the music GUI 60 and/or video GUI 64.

As noted above, in some examples the distribution system 12 may utilize an ad-supported business model in which participants utilize the system in exchange for receiving advertisements. In some examples the distribution system 12 may also enable participants to purchase a subscription in exchange for receiving fewer ads or no ads.

In one potential advantage of the present disclosure, the contribution incentivizer 10 may be configured to dynamically adjust the quantity and/or type of advertisements delivered to a contributor based on an estimated cumulative value that the contributor is adding to the distribution system 12. Such cumulative value may be determined based on interactions by one or more other participants with contributions made by the contributor. In this manner the contribution incentivizer 10 may create a positive feedback cycle in which participants are encouraged to add value to the distribution system 12 by making contributions that enhance other participants' perceived value of the system, which may in turn draw new users to the system.

In some examples, the value associated with contributions by a contributor may be expressed as a point value, and the contribution incentivizer 10 may track one or more point totals associated with each contributor. More particularly, each time another participant interacts with a contribution made by a contributor, the contribution incentivizer 10 receives interaction data 58 indicating the interaction. The contribution incentive program 14 may then assign to the interaction an interaction value 68 based on the nature of the interaction. The interaction value 68 may comprise an interaction point value that is added to the contributor's point total, which may be tracked along with the point totals 70 of all other participants. When the contributor's point total reaches a predetermined threshold, an incentive may be allocated to the contributor comprising a suppression of advertisements that would otherwise be delivered to the contributor.

In some examples, a total quantity of points that are available for allocation in the distribution system 12 may be defined. In one example and upon joining the distribution system 12, each new participant may be initially allocated a quantity of points that later may be programmatically redistributed to other contributors based on the interactions of the new participant with contributions made by the contributors. For example, each new participant may be allocated 1000 points for redistribution. As described in more detail below, as a new participant interacts with contributions made by others, a portion of the new participant's 1000 redistribution point total may be redistributed to the corresponding contributors.

Additionally, as the new participant makes contributions to the distribution system 12 and becomes a contributor, and as other participants interact with those contributions, points may be redistributed from the interacting participants to the contributing new participant (the contributor). In some examples, such redistributed points that are received by the new participant may be collected in a separate “received points” category that reflects a measure of the value added to the distribution system 12 by the new participant.

For example and with reference to the music GUI 60 shown in FIG. 2, a points region 72 may display that the participant 66 (named John) has 5700 redistribution points available for redistribution. The points region 72 may also display that participant John has received 7250 points from other participants based on those participants' interactions with contributions made by John (as a contributor to the distribution system 12).

In this example, when participant John interacts with a contribution from another contributor, a quantity of points may be subtracted from his 5700 points available for redistribution. For example, John may listen to the Awesome Mix 1 playlist that was contributed by Contributor 1. When the song contents of the Awesome Mix 1 playlist are displayed in a digital media display region 76 upon John's selection of the playlist, 5 viewing points 78 may be subtracted from John's 5700 points available for redistribution. Correspondingly, 5 viewing points 78 may be added to Contributor 1's received points total based on John's viewing of Contributor 1's playlist. It will be appreciated that these quantities of points are used merely as examples, and that any suitable quantities of points may be utilized.

Similarly and in some examples, a quantity of points may be added to Contributor 1's received points total and subtracted from John's points available for redistribution based on other interactions with Contributor 1's playlist. Examples of such other interactions include, but are not limited to, playing the playlist, playing an individual song from the playlist, posting a review, rating or recommendation of the playlist, and displaying the playlist for a predetermined amount of time in display region 76. As described in more detail below with respect to other examples, such other interactions may also include sharing the playlist with other participants via email, test message, social networking or other means.

FIG. 2 also shows a first ad 80 and a second ad 82 displayed in ad display regions 52 of the music GUI 60. In some examples, a quantity of points may be added to Contributor 1's received points total and subtracted from John's redistribution point total based on John's ad consumption while viewing or otherwise interacting with Contributor 1's Awesome Mix 1 playlist. For example, 5 points may be subtracted from John's 5700 redistribution points and redistributed to Contributor 1's received point total for each ad delivered to the music GUI 60 while John is viewing the Awesome Mix 1 playlist.

In some examples, different quantities of points may be redistributed based on the type of ad that is served. For example, for each pre-roll ad 54 delivered when John initially views the Awesome Mix 1 playlist, 10 points may be redistributed. For each interstitial ad 56 delivered while John is playing songs from the Awesome Mix 1 playlist, 20 points may be redistributed. In this manner, and because the delivery of an interstitial ad 56 may correspond to John interacting with the Awesome Mix 1 playlist over a longer period of time, such as listening to 6 songs, a greater interaction value may be accorded to interstitial ads as compared to pre-roll ads.

Based on an interaction value 68 assigned to the interaction and corresponding points awarded to Contributor 1, an incentive may be allocated to Contributor 1. More particularly, the incentive may comprise the suppression of advertisements that would otherwise be delivered to Contributor 1 via a request from the distribution system 12 to the ad delivery service 36. In some examples, the contribution incentive program 14 may be configured to establish one or more point thresholds that trigger the suppression of advertisements when a contributor's received points total reaches such thresholds.

For example, a base incentive 84 may comprise a first ad suppression 88 in which a quantity of ads received by the contributor is reduced. In other examples, the first ad suppression 88 may comprise limiting or excluding one or more delivery mechanisms of ads, such as audio, video, or audio/video. In other examples, the first ad suppression 88 may comprise limiting or excluding one or more types of ads, such as interstitial ads, pre-roll ads, banner ads, etc. Various combinations of such ad suppression examples may also be used.

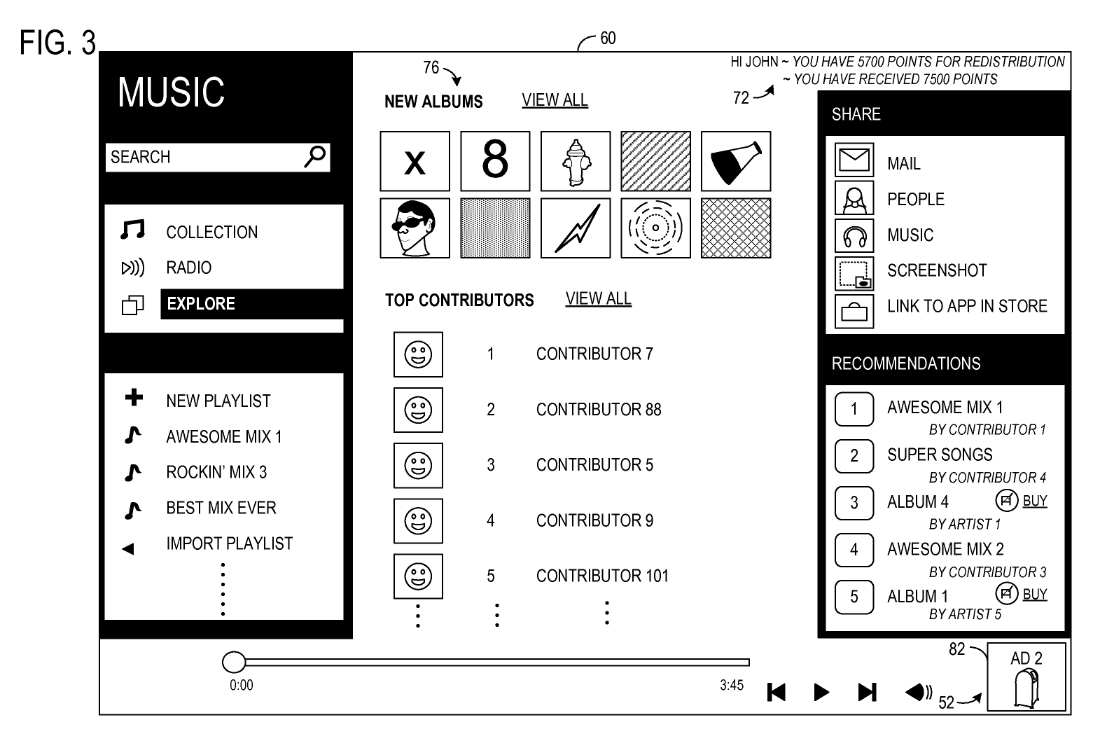

In one example and with reference to FIG. 2, John may be currently receiving a first ad 80 and a second ad 82 on each screen of the music GUI 60. A base threshold of points received may be 7500 points. With reference now to FIG. 3, when John's received points total reaches the 7500 base threshold, the contribution incentivizer 10 may allocate a base ad suppression incentive to John in which the quantity of ads delivered to John's computing device 30 from the ad delivery service 36 via the distribution system 12 is reduced from two ads to one ad 82 on each screen of the music GUI 60. The contribution incentive program 14 may correspondingly provide instructions to the ad delivery service 36 to suppress the delivery of advertisements to John's computing device 30, and in some examples to other computing devices associated with John, according to the allocated incentive.

In another example, when John's received points total reaches 7500, the contribution incentivizer 10 may allocate a first ad suppression incentive to John in which pre-roll ads 54 are delivered to John but interstitial ads 56 are not delivered. Continuing with this example, two or more received points thresholds may also be utilized. For example, in addition to a base threshold of 7500 points, a bonus threshold of 10,000 points may be established. In this example, when John's received points total reaches 10,000, the contribution incentivizer 10 may allocate a bonus ad suppression incentive 90 to John.

For example, the bonus ad suppression incentive 90 may comprise a first and second ad suppression 92 in which the delivery of both interstitial ads 56 and pre-roll ads 54 to John is limited or halted. The contribution incentive program 14 may correspondingly provide instructions to the ad delivery service 36 to suppress the delivery of both types of advertisements to John's account according to the allocated incentive.

In some examples, the contribution incentivizer 10 may dynamically balance the quantity of ads delivered to the participants in the distribution system 12. For example, when a quantity of ads delivered to John is reduced, an equal quantity of ads delivered to one or more other participants may be increased. In some examples and to ensure a sufficiently enjoyable user experience for all participants, a maximum quantity of ads that defines the maximum number of ads that may be received by a participant may be implemented. For example, such a maximum quantity may ensure that no participant receives more than one ad for every 6 songs played by the participant via the music GUI 60.

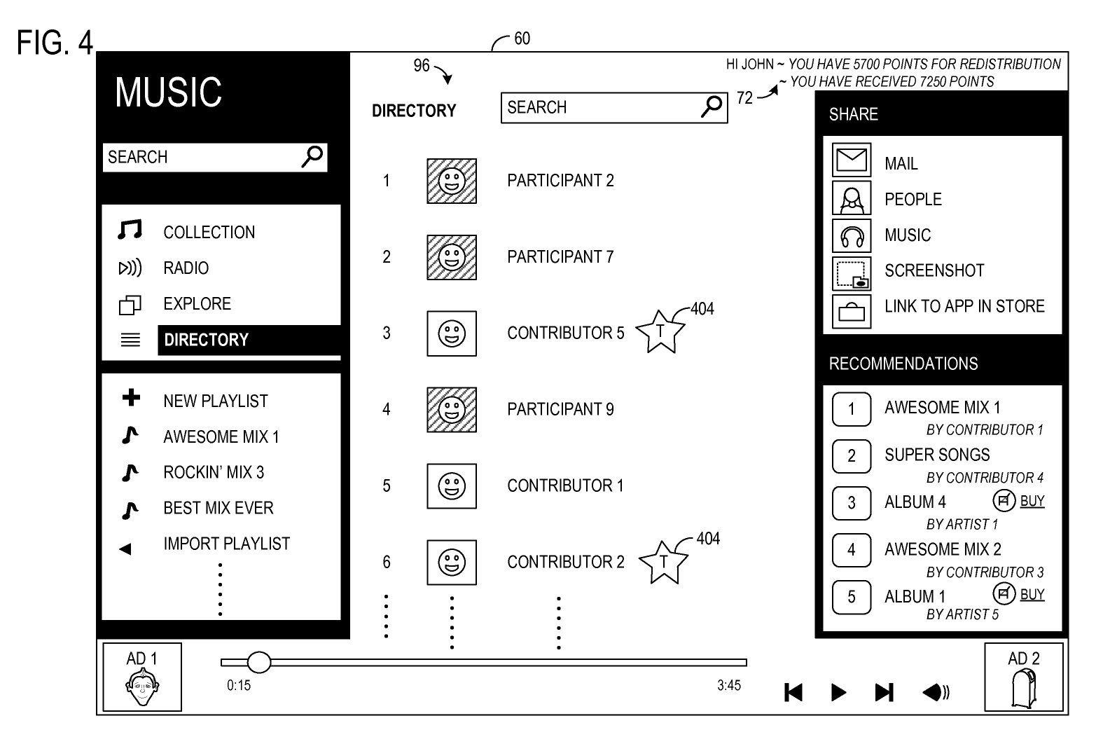

In some examples, one or more other incentives may be offered to contributors in addition to advertising suppression. For example, contributors who contribute the most value to the distribution system 12 may be lauded within the system as valued contributors. In one example, one or more contributors may reach a received points total that exceeds a top contributor threshold, such as 50,000 points. With reference now to FIG. 4 and the searchable directory region 96 of the music GUI 60, the contribution incentive program 14 may display a graphical indicator 404 of status as a valued contributor in connection with an entry in the directory corresponding to the contributors. In the example of FIG. 4, a valued contributor “Tastemaker” indicator 404 is displayed adjacent to entries for Contributor 5 and Contributor 2. In this manner, top contributors to the distribution system 12 may be promoted by the distribution system 12 to the other participants.

Other examples of incentives that may be offered to contributors in addition to advertising suppression include free or discounted purchases via the distribution system 12, such as free music, video rentals, etc.

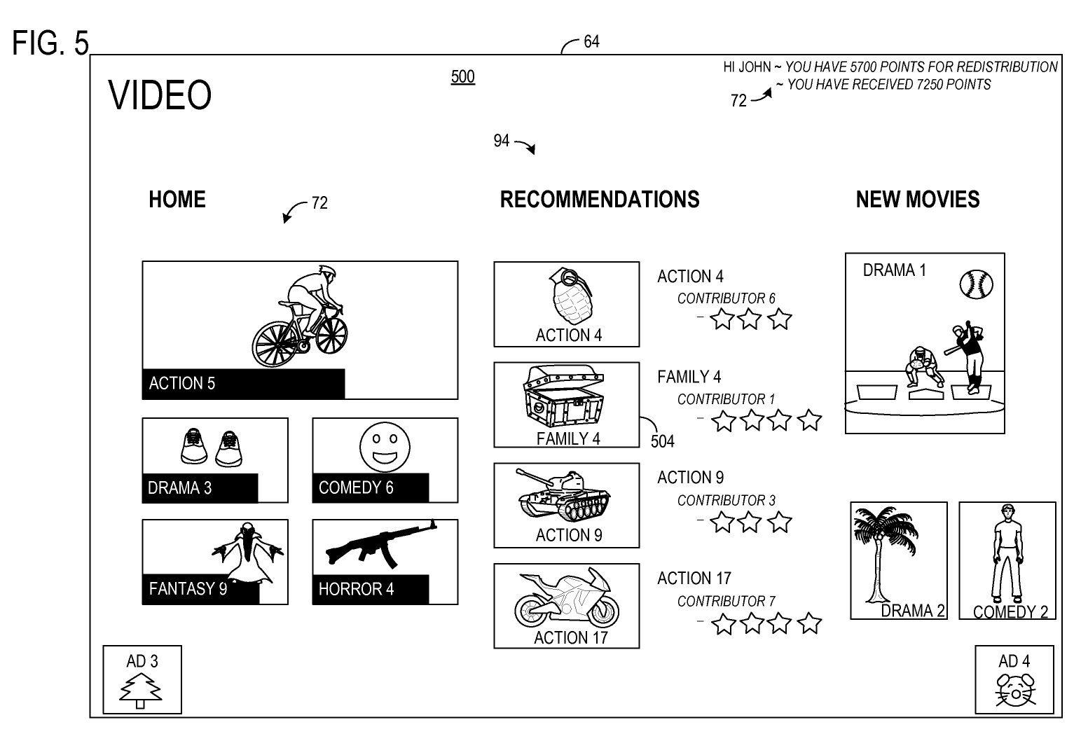

With reference now to FIG. 5, an example home screen 500 from a video GUI 64 that forms part of the distribution system GUI 40 is provided. In some examples a participant may watch a video media item, such as a movie or a television show, and may rate the item. For example, Contributor 1 has given the Family 4 movie a 4 out of 4 star rating, and such rating is displayed next to the Family 4 movie hyperlink 504 in a Recommendations region 94 of the video GUI 64. If participant John selects the Family 4 movie hyperlink 504 next to the corresponding rating provided by Contributor 1, Contributor 1 may be allocated a quantity of incentive points based on John's selection.

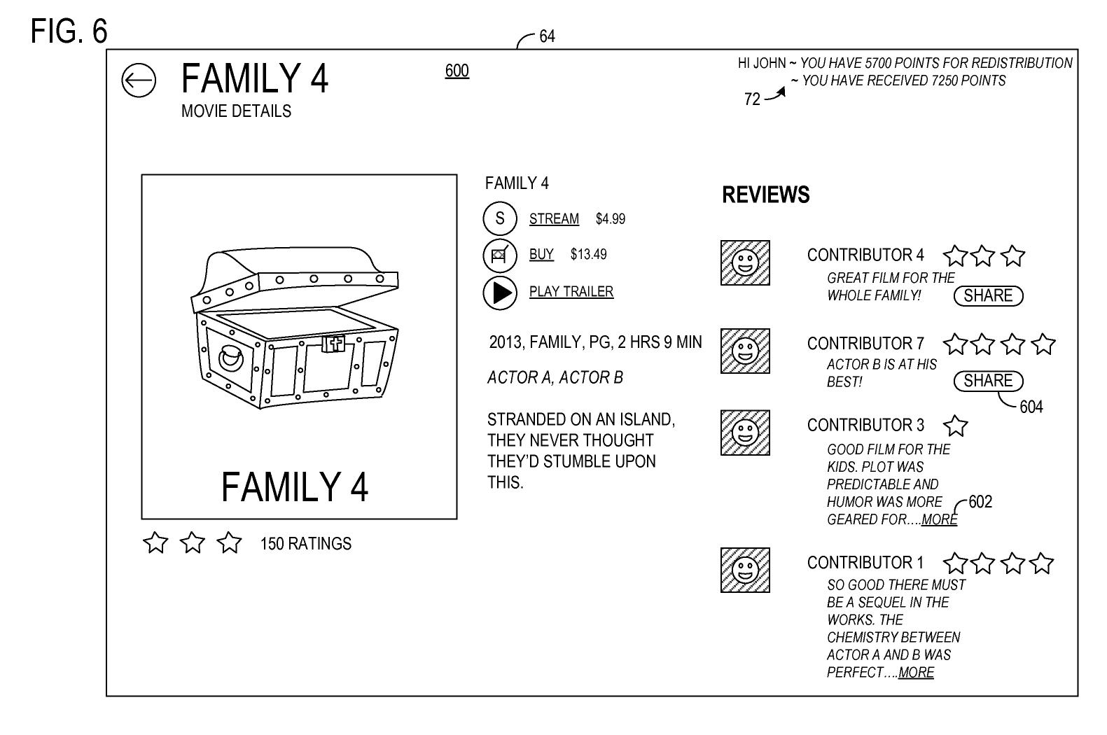

With reference now to FIG. 6 and when the Family 4 movie hyperlink 504 is selected, a movie detail screen 600 may be displayed in the video GUI 64. The movie detail screen 600 may include one or more reviews of the Family 4 movie provided by other contributors. For example, a review contributed by Contributor 1 notes in part, “So good there must be a sequel in the works. The chemistry between Actor A and B was perfect . . . ”. Contributor 1's 4-star rating is also displayed adjacent to the review.

In one example contributor John may select the more hyperlink 602 at the end of Contributor 1's review to view the entire review. In this example, the contribution incentive program 14 may receive interaction data 58 in the form of viewing data that indicates that John has viewed the review contributed by Contributor 1. Accordingly, a quantity of viewing points may be added to the received points total of Contributor 1.

In another example, John may particularly value movie reviews contributed by Contributor 7. A review of Family 4 contributed by Contributor 7 and displayed on movie detail screen 600 notes, “Actor B is at his best!” Contributor 7's 4-star rating is also displayed adjacent to the review. John may select the Share button 604 next to Contributor 7's review to share this review with one or more other participants. For example, selecting the Share button 604 may trigger a pop-up window that offers John one or more sharing options, such as emailing the review, messaging the review, and posting the review to a social networking site.

When participant John shares the review contributed by Contributor 7, the contribution incentivizer 10 may receive interaction data 58 in the form of sharing data indicating that John has shared Contributor 7's review via the distribution system 12. Contributor 7 may then be allocated a quantity of incentive points based on John's sharing of the review.

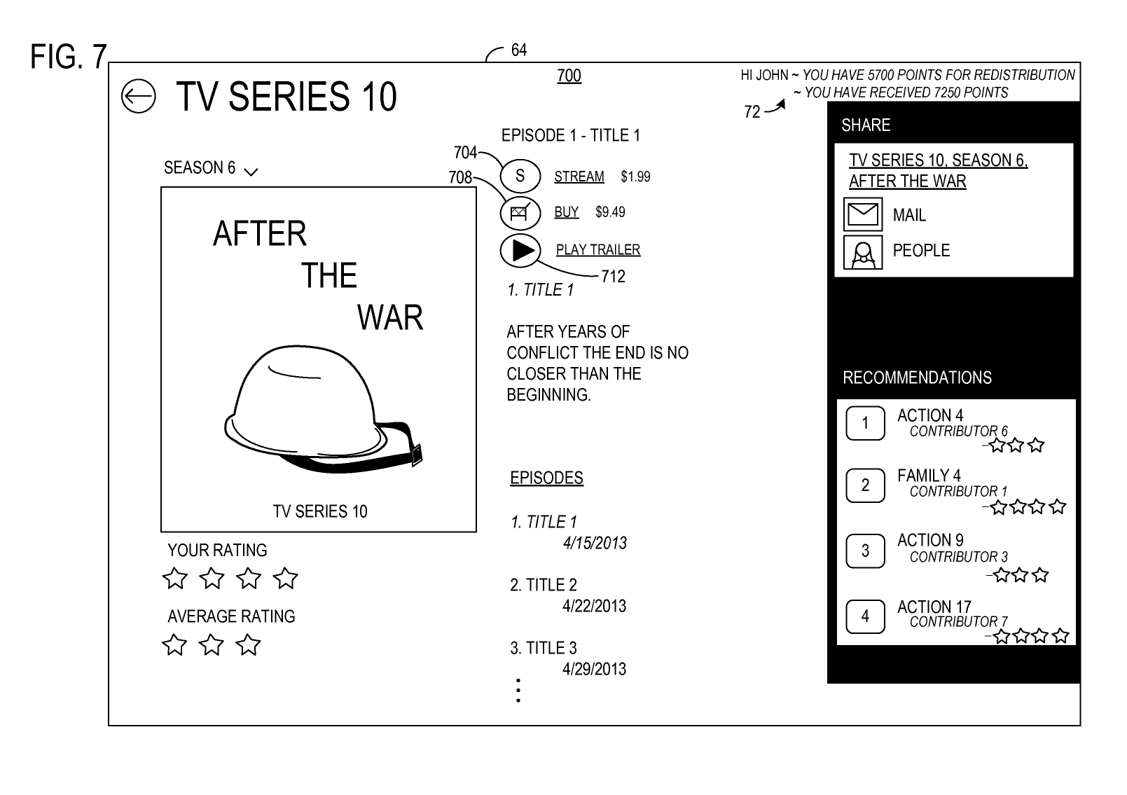

In another example, a friend of participant John may email to John a review of Season 6 of TV Series 10 that was posted by Contributor 1. John may read the review and select a selectable icon of Season 6 of TV Series 10 that is adjacent to the review in the email. With reference now to FIG. 7, a TV series screen 700 including details regarding Season 6 of TV Series 10 may be then displayed in the video GUI 64. The TV series screen 700 may include one or more selectable options for the participant John to consume Episode 1—Title 1 of Season 6 of the TV Series 10. For example, a Stream selector 704 may stream the episode to the computing device 30, a Buy selector 708 may download the episode to the computing device, and a Play Trailer selector 712 may stream the trailer for the episode to the computing device.

In some examples, contributor John may stream or download Season 6 of TV Series 10 by selecting the Stream selector 704 or the Buy selector 708. In this example, the contribution incentive program 14 may receive interaction data 58 in the form of conversion data that indicates that John has downloaded or streamed TV Series 10 Season 6 after viewing the review of this digital media item contributed by Contributor 1. Accordingly, in this example a quantity of conversion points may be added to the received points total of Contributor 1.

In other examples, a contributor may be allocated incentive points for influencing new users to join the distribution system 12. For example, a contributor may send invitations to one or more friends who are not currently participants in the distribution system 12. If one of the friends uses the invitation to join the system, then the contributor may be allocated referral points to the contributors received points total.

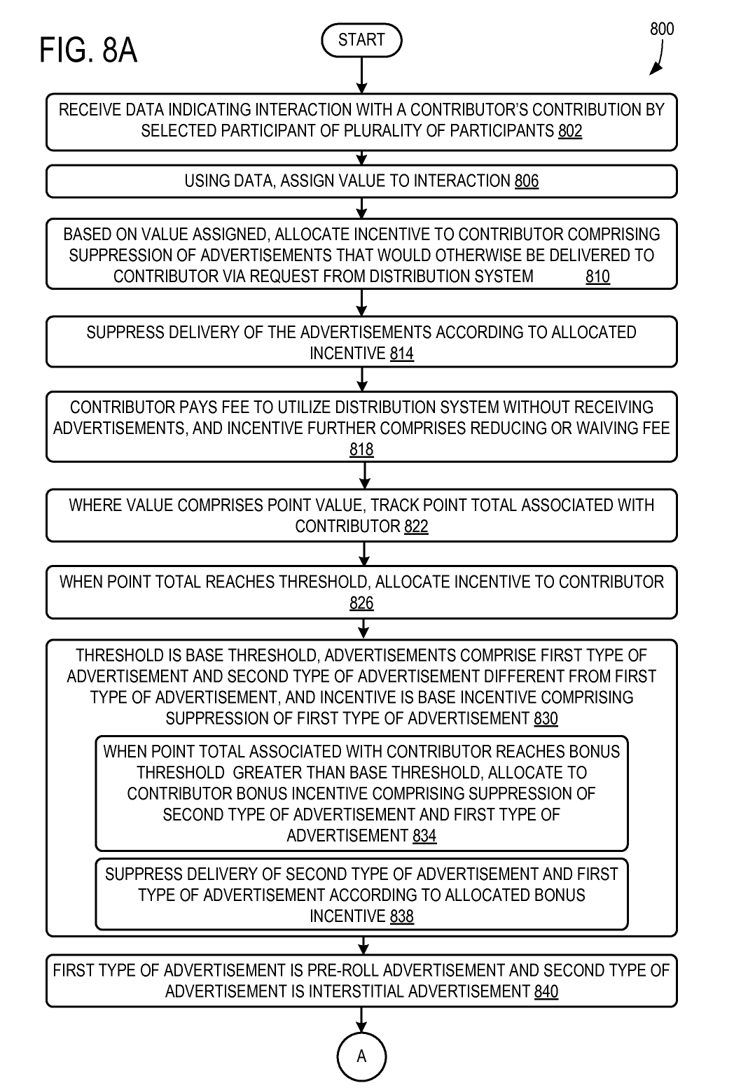

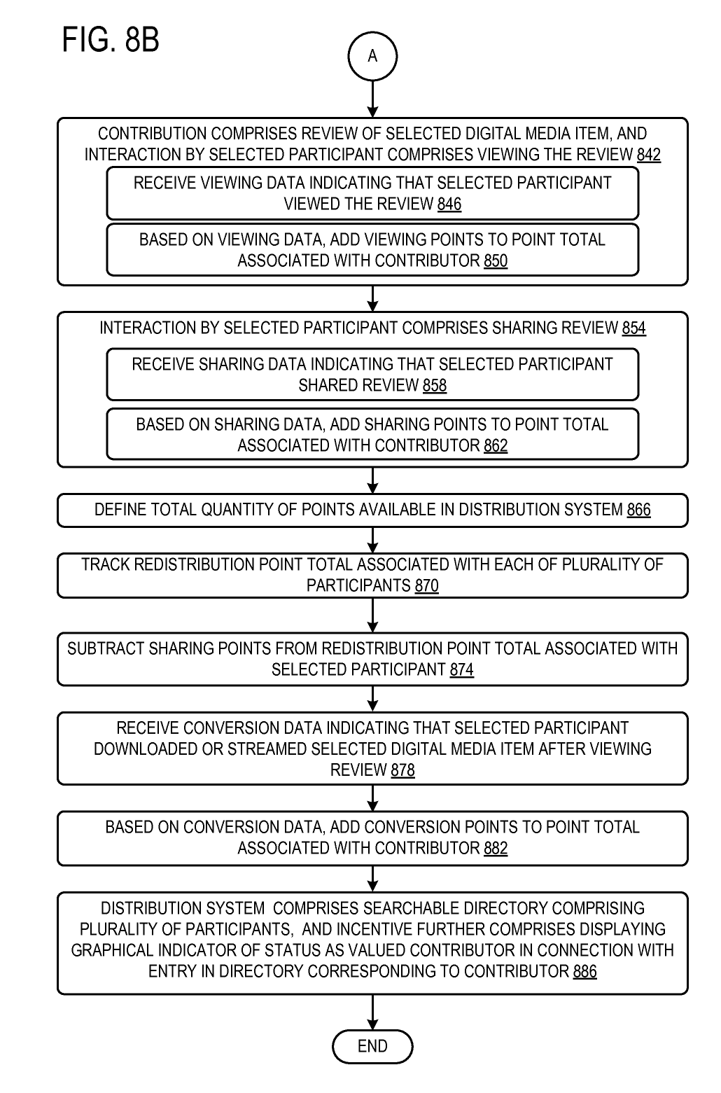

FIGS. 8A and 8B illustrate a flow chart of a method 800 for rewarding a contributor based on a contribution related to one or more digital media items in a distribution system according to an embodiment of the present disclosure. The following description of method 800 is provided with reference to the software and hardware components of the contribution incentivizer 10 and distribution system 12 described above and shown in FIG. 1. It will be appreciated that method 800 may also be performed in other contexts using other suitable hardware and software components.

With reference to FIG. 8A, at 802 the method 800 may include receiving data indicating an interaction with the contribution by a selected participant of a plurality of participants. At 806 the method 800 may include, using the data, assigning a value to the interaction with the contribution. At 810 the method 800 may include, based on the value assigned to the interaction, allocating an incentive to the contributor, wherein the incentive comprises a suppression of advertisements that would otherwise be delivered to the contributor via a request from the distribution system. At 814 the method 800 may include suppressing a delivery of the advertisements to the contributor according to the allocated incentive.

At 818, where the contributor pays a fee to utilize the distribution system without receiving advertisements, the incentive may further comprise reducing or waiving the fee. At 822 the method 800 may include, where the value comprises a point value, tracking a point total associated with the contributor. At 826 the method 800 may include, when the point total associated with the contributor reaches a threshold, allocating the incentive to the contributor.

At 830, the threshold may be a base threshold, the advertisements may comprise a first type of advertisement and a second type of advertisement different from the first type of advertisement, and the incentive may be a base incentive comprising the suppression of the first type of advertisement. At 834 the method 800 may include, when the point total associated with the contributor reaches a bonus threshold that is greater than the base threshold, allocating to the contributor a bonus incentive comprising the suppression of the second type of advertisement and the first type of advertisement. At 838 the method 800 may include suppressing a delivery of the second type of advertisement and the first type of advertisement to the contributor according to the allocated bonus incentive.

At 840 the first type of advertisement may be a pre-roll advertisement and the second type of advertisement may be an interstitial advertisement. Turning now to FIG. 8B, at 842 the contribution may comprise a review of a selected digital media item from the one or more digital media items, and the interaction by the selected participant may comprise viewing the review. At 846 the method 800 may include receiving viewing data indicating that the selected participant viewed the review via the distribution system. At 850 the method 800 may include, based on the viewing data, adding viewing points to the point total associated with the contributor.

At 854, the interaction by the selected participant may further comprise sharing the review contributed by the contributor via the distribution system. At 858 the method 800 may comprise receiving sharing data indicating that the selected participant shared the review via the distribution system. At 862 the method 800 may include, based on the sharing data, adding sharing points to the point total associated with the contributor.

At 866 the method 800 may include defining a total quantity of points available in the distribution system. At 870 the method 800 may include tracking a redistribution point total associated with each of the plurality of participants. At 874 the method 800 may include subtracting the sharing points from the redistribution point total associated with the selected participant. At 878 the method 800 may include receiving conversion data indicating that the selected participant downloaded or streamed the selected digital media item after viewing the review. At 882 the method 800 may include, based on the conversion data, adding conversion points to the point total associated with the contributor. At 886 the method 800 may include, where the distribution system comprises a searchable directory comprising the plurality of participants, the incentive further comprising displaying a graphical indicator of status as a valued contributor in connection with an entry in the directory corresponding to the contributor.

It will be appreciated that method 800 is provided by way of example and is not meant to be limiting. Therefore, it is to be understood that method 800 may include additional and/or alternative steps than those illustrated in FIGS. 8A and 8B. Further, it is to be understood that method 800 may be performed in any suitable order. Further still, it is to be understood that one or more steps may be omitted from method 800 without departing from the scope of this disclosure.

FIG. 9 schematically shows a nonlimiting embodiment of a computing system 900 that may perform one or more of the above described methods and processes. Contribution incentivizer 10, user computing device 30, user computing device 32, and advertisement delivery service 36 may take the form of computing system 900. Computing system 900 is shown in simplified form. It is to be understood that virtually any computer architecture may be used without departing from the scope of this disclosure. In different embodiments, computing system 900 may take the form of a mainframe computer, server computer, desktop computer, laptop computer, tablet computer, home entertainment computer, network computing device, mobile computing device, mobile communication device, smart phone, gaming device, etc.

As shown in FIG. 9, computing system 900 includes a logic subsystem 904 and a storage subsystem 908. Computing system 900 may optionally include a display subsystem 912, a communication subsystem 916, a sensor subsystem 920, an input subsystem 322 and/or other subsystems and components not shown in FIG. 9. Computing system 900 may also include computer readable media, with the computer readable media including computer readable storage media and computer readable communication media. Computing system 900 may also optionally include other user input devices such as microphones, keyboards, mice, game controllers, and/or touch screens, for example. Further, in some embodiments the methods and processes described herein may be implemented as a computer application, computer service, computer API, computer library, and/or other computer program product in a computing system that includes one or more computers.

Logic subsystem 904 may include one or more physical devices configured to execute one or more instructions. For example, the logic subsystem 904 may be configured to execute one or more instructions that are part of one or more applications, services, programs, routines, libraries, objects, components, data structures, or other logical constructs. Such instructions may be implemented to perform a task, implement a data type, transform the state of one or more devices, or otherwise arrive at a desired result.

The logic subsystem 904 may include one or more processors that are configured to execute software instructions. Additionally or alternatively, the logic subsystem may include one or more hardware or firmware logic machines configured to execute hardware or firmware instructions. Processors of the logic subsystem may be single core or multicore, and the programs executed thereon may be configured for parallel or distributed processing. The logic subsystem may optionally include individual components that are distributed throughout two or more devices, which may be remotely located and/or configured for coordinated processing. One or more aspects of the logic subsystem may be virtualized and executed by remotely accessible networked computing devices configured in a cloud computing configuration.

Storage subsystem 908 may include one or more physical, persistent devices configured to hold data and/or instructions executable by the logic subsystem 904 to implement the herein described methods and processes. When such methods and processes are implemented, the state of storage subsystem 908 may be transformed (e.g., to hold different data).

Storage subsystem 908 may include removable media and/or built-in devices. Storage subsystem 908 may include optical memory devices (e.g., CD, DVD, HD-DVD, Blu-Ray Disc, etc.), semiconductor memory devices (e.g., RAM, EPROM, EEPROM, etc.) and/or magnetic memory devices (e.g., hard disk drive, floppy disk drive, tape drive, MRAM, etc.), among others. Storage subsystem 908 may include devices with one or more of the following characteristics: volatile, nonvolatile, dynamic, static, read/write, read-only, random access, sequential access, location addressable, file addressable, and content addressable.

In some embodiments, aspects of logic subsystem 904 and storage subsystem 908 may be integrated into one or more common devices through which the functionally described herein may be enacted, at least in part. Such hardware-logic components may include field-programmable gate arrays (FPGAs), program- and application-specific integrated circuits (PASIC/ASICs), program- and application-specific standard products (PSSP/ASSPs), system-on-a-chip (SOC) systems, and complex programmable logic devices (CPLDs), for example.

FIG. 9 also shows an aspect of the storage subsystem 908 in the form of removable computer readable storage media 924, which may be used to store data and/or instructions in a non-volatile manner which are executable to implement the methods and processes described herein. Removable computer-readable storage media 924 may take the form of CDs, DVDs, HD-DVDs, Blu-Ray Discs, EEPROMs, and/or floppy disks, among others.

It is to be appreciated that storage subsystem 908 includes one or more physical, persistent devices. In contrast, in some embodiments aspects of the instructions described herein may be propagated in a transitory fashion by a pure signal (e.g., an electromagnetic signal, an optical signal, etc.) that is not held by a physical device for at least a finite duration. Furthermore, data and/or other forms of information pertaining to the present disclosure may be propagated by a pure signal via computer-readable communication media.

When included, display subsystem 912 may be used to present a visual representation of data held by storage subsystem 908. As the above described methods and processes change the data held by the storage subsystem 908, and thus transform the state of the storage subsystem, the state of the display subsystem 912 may likewise be transformed to visually represent changes in the underlying data. The display subsystem 912 may include one or more display devices utilizing virtually any type of technology. Such display devices may be combined with logic subsystem 904 and/or storage subsystem 908 in a shared enclosure, or such display devices may be peripheral display devices. The display subsystem 912 may include, for example, the display 42 shown in FIG. 1.

When included, communication subsystem 916 may be configured to communicatively couple computing system 900 with one or more networks and/or one or more other computing devices. Communication subsystem 916 may include wired and/or wireless communication devices compatible with one or more different communication protocols. As nonlimiting examples, the communication subsystem 916 may be configured for communication via a wireless telephone network, a wireless local area network, a wired local area network, a wireless wide area network, a wired wide area network, etc. In some embodiments, the communication subsystem may allow computing system 900 to send and/or receive messages to and/or from other devices via a network such as the Internet.

When included, sensor subsystem 920 may include one or more sensors configured to sense different physical phenomenon (e.g., visible light, infrared light, sound, acceleration, orientation, position, etc.). Sensor subsystem 920 may be configured to provide sensor data to logic subsystem 904, for example.

When included, input subsystem 922 may comprise or interface with one or more sensors or user-input devices such as a microphone, gaze tracking system, voice recognizer, game controller, gesture input detection device, inertial measurement unit, keyboard, mouse, or touch screen. In some embodiments, the input subsystem 922 may comprise or interface with selected natural user input (NUI) componentry. Such componentry may be integrated or peripheral, and the transduction and/or processing of input actions may be handled on- or off-board. Example NUI componentry may include a microphone for speech and/or voice recognition; an infrared, color, stereoscopic, and/or depth camera for machine vision and/or gesture recognition; a head tracker, eye or gaze tracker, accelerometer, and/or gyroscope for motion detection and/or intent recognition; as well as electric-field sensing componentry for assessing brain activity.

The term “program” may be used to describe an aspect of the contribution incentivizer 10 that is implemented to perform one or more particular functions. In some cases, such a program may be instantiated via logic subsystem 904 executing instructions held by storage subsystem 908. It is to be understood that different programs may be instantiated from the same application, service, code block, object, library, routine, API, function, etc. Likewise, the same program may be instantiated by different applications, services, code blocks, objects, routines, APIs, functions, etc. The term “program” is meant to encompass individual or groups of executable files, data files, libraries, drivers, scripts, database records, etc.

The term “service” may be used to describe an application program executable across multiple user sessions. A service may be available to one or more system components, programs, and/or other services. In some implementations, a service may run on one or more server-computing devices

It is to be understood that the configurations and/or approaches described herein are exemplary in nature, and that these specific embodiments or examples are not to be considered in a limiting sense, because numerous variations are possible. The specific routines or methods described herein may represent one or more of any number of processing strategies. As such, various acts illustrated may be performed in the sequence illustrated, in other sequences, in parallel, or in some cases omitted. Likewise, the order of the above-described processes may be changed.

The subject matter of the present disclosure includes all novel and nonobvious combinations and subcombinations of the various processes, systems and configurations, and other features, functions, acts, and/or properties disclosed herein, as well as any and all equivalents thereof.

1. In a computing device implementing a distribution system in which a plurality of digital media items are distributed to a plurality of participants that comprise a plurality of contributors, a method for rewarding a contributor of the plurality of contributors based on a contribution made by the contributor, wherein the contribution relates to one or more of the digital media items, the method comprising:
receiving data indicating an interaction with the contribution by a selected participant of the plurality of participants;
using the data, assigning a value to the interaction with the contribution;
based on the value assigned to the interaction, allocating an incentive to the contributor, wherein the incentive comprises a suppression of advertisements that would otherwise be delivered to the contributor via a request from the distribution system; and
suppressing a delivery of the advertisements to the contributor according to the allocated incentive.

2. The method of claim 1, wherein the value comprises a point value, the method further comprising:
tracking a point total associated with the contributor; and
when the point total associated with the contributor reaches a threshold, allocating the incentive to the contributor.

3. The method of claim 2, wherein the threshold is a base threshold, the advertisements comprise a first type of advertisement and a second type of advertisement different from the first type of advertisement, and the incentive is a base incentive comprising the suppression of the first type of advertisement, the method further comprising:
when the point total associated with the contributor reaches a bonus threshold that is greater than the base threshold, allocating to the contributor a bonus incentive comprising the suppression of the second type of advertisement and the first type of advertisement, and suppressing a delivery of the second type of advertisement and the first type of advertisement to the contributor according to the allocated bonus incentive.

4. The method of claim 3, wherein the first type of advertisement is a pre-roll advertisement and the second type of advertisement is an interstitial advertisement.

5. The method of claim 2, wherein the contribution comprises a review of a selected digital media item from the digital media items, and wherein the interaction by the selected participant comprises viewing the review, the method further comprising:
receiving viewing data indicating that the selected participant viewed the review via the distribution system; and
based on the viewing data, adding viewing points to the point total associated with the contributor.

6. The method of claim 5, wherein the interaction by the selected participant further comprises sharing the review contributed by the contributor via the distribution system, the method further comprising:
receiving sharing data indicating that the selected participant shared the review via the distribution system; and
based on the sharing data, adding sharing points to the point total associated with the contributor.

7. The method of claim 6, wherein the point total is a received point total, the method further comprising:
defining a total quantity of points available in the distribution system;
tracking a redistribution point total associated with each of the plurality of participants; and
subtracting the sharing points from the redistribution point total associated with the selected participant.

8. The method of claim 5, further comprising:
receiving conversion data indicating that the selected participant downloaded or streamed the selected digital media item after viewing the review; and
based on the conversion data, adding conversion points to the point total associated with the contributor.

9. The method of claim 1, wherein the contributor pays a fee to utilize the distribution system without receiving advertisements, and wherein the incentive further comprises reducing or waiving the fee.

10. The method of claim 1, wherein the distribution system comprises a searchable directory comprising the plurality of participants, and wherein the incentive further comprises displaying a graphical indicator of status as a valued contributor in connection with an entry in the directory corresponding to the contributor.

11. In a distribution system in which a plurality of digital media items are distributed to a plurality of participants that comprise a plurality of contributors, a contribution incentivizer for rewarding a contributor of the plurality of contributors based on a contribution made by the contributor, wherein the contribution relates to one or more of the digital media items, the contribution incentivizer comprising:
a contribution incentive program comprising instructions stored in a mass storage of the contribution incentivizer, the contribution incentive program configured to:
receive data indicating an interaction with the contribution by a selected participant of the plurality of participants;
using the data, assign a value to the interaction with the contribution;
based on the value assigned to the interaction, allocate an incentive to the contributor, wherein the incentive comprises a suppression of advertisements that would otherwise be delivered to the contributor via a request from the distribution system; and
suppress a delivery of the advertisements to the contributor according to the allocated incentive.

12. The contribution incentivizer of claim 11, wherein the value comprises a point value, the threshold is a base threshold, the advertisements comprise a first type of advertisement and a second type of advertisement different from the first type of advertisement, and the incentive is a base incentive comprising the suppression of the first type of advertisement, and the contribution incentive program is further configured to:
track a point total associated with the contributor;
when the point total associated with the contributor reaches a threshold, allocate the incentive to the contributor; and
when the point total associated with the contributor reaches a bonus threshold that is greater than the base threshold, allocate to the contributor a bonus incentive comprising the suppression of the second type of advertisement and the first type of advertisement, and suppress the second type of advertisement and the first type of advertisement according to the allocated bonus incentive.

13. The contribution incentivizer of claim 12, wherein the first type of advertisement is a pre-roll advertisement and the second type of advertisement is an interstitial advertisement.

14. The contribution incentivizer of claim 12, wherein the contribution comprises a review of a selected digital media item from the digital media items, and wherein the interaction by the selected participant comprises viewing the review, and the contribution incentive program is further configured to:
receive viewing data indicating that the selected participant viewed the review via the distribution system; and
based on the viewing data, add viewing points to the point total associated with the contributor.

15. The contribution incentivizer of claim 14, wherein the interaction by the selected participant further comprises sharing the review contributed by the contributor via the distribution system, and the contribution incentive program is further configured to:
receive sharing data indicating that the selected participant shared the review via the distribution system; and
based on the sharing data, add sharing points to the point total associated with the contributor.

16. The contribution incentivizer of claim 15, wherein the point total is a received point total, and the contribution incentive program is further configured to:
define a total quantity of points available in the distribution system;
track a redistribution point total associated with each of the plurality of participants; and
subtract the sharing points from the redistribution point total associated with the selected participant.

17. The contribution incentivizer of claim 14, wherein the contribution incentive program is further configured to:
receive conversion data indicating that the selected participant downloaded or streamed the selected digital media item after viewing the review; and
based on the conversion data, add conversion points to the point total associated with the contribution.

18. The contribution incentivizer of claim 11, wherein the contributor pays a fee to utilize the distribution system without receiving advertisements, and wherein the incentive further comprises reducing or waiving the fee.

19. The contribution incentivizer of claim 11, wherein the distribution system comprises a searchable directory comprising the plurality of participants, and wherein the incentive further comprises displaying a graphical indicator of status as a valued contributor in connection with an entry in the directory corresponding to the contributor.

20. In a computing device implementing a distribution system in which a plurality of digital media items are distributed to a plurality of participants that comprise a plurality of contributors, a method for rewarding a contributor of the plurality of contributors based on a contribution made by the contributor, wherein the contribution relates to one or more of the digital media items, the method comprising:
receiving data indicating an interaction with the contribution by a selected participant of the plurality of participants;
using the data, assigning a point value to the interaction with the contribution;
adding the point value to a received point total associated with the contributor;
when the received point total associated with the contributor reaches a base threshold, allocating a base incentive to the contributor, wherein the base incentive comprises a suppression of a first type of advertisement that would otherwise be delivered to the contributor via a request from the distribution system;
suppressing a delivery of the first type of advertisement to the contributor according to the base incentive;
when the received point total associated with the contributor reaches a bonus threshold that is greater than the base threshold, allocating a bonus incentive to the contributor comprising the suppression of the first type of advertisement and a second type of advertisement different from the first type of advertisement that would otherwise be delivered to the contributor via a request from the distribution system; and
suppressing a delivery of the second type of advertisement and the first type of advertisement to the contributor according to the bonus incentive.
